(19) United States
(12) Patent Application Publication
(10) Pub. No.: US 2024/0378941 A1
(43) Pub. Date: Nov. 14, 2024

(54) GAMING MACHINE AND METHOD WITH SYMBOL MATRIX AND ACTIVATED NUMERICAL REELS

(71) Applicant: Everi Games Inc., Austin, TX (US)

(72) Inventors: Dustin Dies, Spring, TX (US); Michael Wabschall, Austin, TX (US)

(73) Assignee: Everi Games Inc., Austin, TX (US)

(21) Appl. No.: 18/195,797

(22) Filed: May 10, 2023

(51) Int. Cl. G07F 17/32

(52) U.S. Cl. CPC G07F 17/3213; G07F 17/3262

(57) ABSTRACT

A gaming machine, program product, and method for operating a gaming machine in which virtual or mechanical reels include numbers from which a prize amount is produced by concatenation. In response to a designated triggering pattern appearing in a gaming matrix in a first display area, a gaming machine causes at least two reels to spin and stop in a second display area to display a numerical value defined by concatenating the numerical symbols from the game symbol set aligned along a payline, the displayed numerical value comprising at least a portion of a randomly selected game outcome.

### FIELD OF THE INVENTION

This invention relates to gaming systems and to gaming machines, and in particular to reel based gaming machines including numbers in the reel symbols.

### BACKGROUND

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Many video-based gaming machines have three or five spinning reels that may be stopped to display a matrix of game symbols. The symbols displayed on the stopped reels correlate to a result of the game. Video-based gaming machines may also be used to show card games or various types of competitions such as simulated horse races in which wagers may be placed.

Game manufacturers are continuously pressed to develop new game presentations, formats, and game graphics in an attempt to provide high entertainment value for players and thereby attract and keep players. What is needed are ways to provide both anticipation and excitement to players while providing more variability in game results.

### SUMMARY OF THE INVENTION

The present invention includes gaming methods, gaming machines, networked gaming systems that provide improvements to feature games played on slot machines or other gaming machines. A gaming machine and method for operating a game are provided in which virtual or mechanical reels include numbers from which a prize amount is produced by concatenation.

According to a first aspect of the invention, a method for controlling operation of a gaming machine. The method includes, under control of a processing system of the gaming machine, storing a first data structure in a memory of the gaming machine, the first data structure for forming a matrix of symbol locations on a display system of the gaming machine, and storing a second data structure for forming set of reel strips for a plurality of reels each including a plurality of second symbol locations containing a game symbol from a game symbol set which includes numerical symbols with single digit numbers including “0” and double digit numbers including “00”. In response to an input entered through a player input device of the gaming machine and under control of the processing system, the method includes causing the display to populate the matrix of first symbol locations in a first area of the display system and, responsive to a designated triggering pattern appearing therein, cause at least two of the plurality of reels to spin and stop in a second area of the display system to display a numerical value defined by concatenating the numerical symbols from the game symbol set aligned along a payline, the displayed numerical value comprising at least a portion of a randomly selected game outcome.

In some implementations of the first aspect, all of the game symbols in the game symbol set comprise positive single digit numbers, positive double digit numbers, “0,” “00,” and blank symbols.

In some implementations of the first aspect, responsive to a designated triggering pattern, the method includes causing the at least two reels to change from a first state in which they are shown to be concealed, and a second state in which they are shown to be active and displaying symbols.

In some implementations of the first aspect, responsive to the triggering pattern, the method includes selecting the at least two of the plurality of reels that spin and stop to be reels that are aligned with two or more symbols containing the triggering pattern.

In some implementations of the first aspect, the method includes, responsive to a spin result of the reels containing only ‘0’ or ‘00’ values, causing the remaining reels to spin and stop to display a numerical value defined by concatenating the numerical symbols from the game symbol set aligned along the payline, the displayed numerical value comprising at least a portion of a randomly selected game outcome.

In some implementations of the first aspect, the randomly selected game outcome is selected by: performing a prize amount random selection to identify an outcome prize amount; and performing an outcome sequence random selection to identify an outcome sequence from a group of outcome sequences each providing the identified outcome prize amount.

In some implementations of the first aspect, the method further includes: storing a second data structure in the memory, the second data structure comprising a first group of outcome sequences each corresponding to a respective prize amount and each including only base game outcome sequences; storing a third data structure in the memory, the third data structure comprising a second group of outcome sequences each corresponding to a respective prize amount and each including only outcome sequences with a base game outcome and a bonus game outcome; and in response to the input and after identifying an outcome prize amount, randomly selecting an outcome sequence from one of the first group of outcome sequences or the second group of outcome sequences.

In some implementations of the first aspect, the method also includes, under control of the processing system, causing the display system to show each of the plurality of reels spin and then come to a stop to display a first group of symbols from the game symbol set aligned along the payline, the first group of symbols including “0”; and under control of the processing system, causing a reel that does not display “0” in the first group of symbols from the game symbol set to respin and then come to a stop to display the numerical value defined by concatenating the numerical symbols from the game symbol set aligned along the payline.

According to another aspect of the invention, a special purpose gaming machine includes a cabinet in which is mounted one or more displays including a reel display. The gaming machine includes tangible, nontransistory computer readable media executable by at least one processor to perform the method.

Another aspect of the invention is a computer program stored on a tangible non-transitory readable medium. The software version is, of course, typically designed to be executed by a gaming machine or networked gaming system. The software includes multiple portions of computer executable code referred to as program code. Gaming results are provided in response to a wager and displayed by display program code that generates simulated slot reels each including one or more symbol locations. The program also has game controller program code for determining game play results involving spins or other randomization of the base and bonus round game presentations.

Another aspect of the invention is a gaming system that includes one or more gaming servers, and a group of electronic gaming machines connected to the servers by a network, programmed to provide one of more of the methods described herein. The various functionality described herein may be distributed between the electronic gaming machines and the gaming servers in any practically functional way. For example, the current preferred architecture is for the servers to determine all aspects of game logic, random number generation, and prize awards. The servers may be special purpose gaming servers. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIGS. 1-6 are a sequence of game screen diagrams illustrating an example base game scenario according to an example embodiment.

FIGS. 7-13 are a sequence of game screen diagrams illustrating another game scenario according to another example embodiment.

FIGS. 14-25 are a sequence of game screen diagrams illustrating an example free spin bonus round scenario according to an example embodiment.

FIG. 26 is a diagram of several reel strips according to an example embodiment.

FIG. 27 is a flowchart of a process for providing a base game according to an example embodiment.

FIG. 28 is a flowchart of a process for providing a “win what you see” feature according to some embodiments.

FIG. 29 is a flowchart of a process for providing a free spin bonus game according to some embodiments.

FIG. 30 is a flowchart of a process for providing a bonus game

according to an example embodiment.

FIG. 31 is a front perspective view of a gaming machine which may be used in a gaming system of the present invention.

FIG. 32 is a block diagram showing various electronic components of the gaming machine shown in FIG. 5 together with additional gaming system components.

FIG. 33 is a system block diagram of a gaming system according to one embodiment of the present invention.

### DETAILED DESCRIPTION OF EXAMPLE EMBODIMENTS

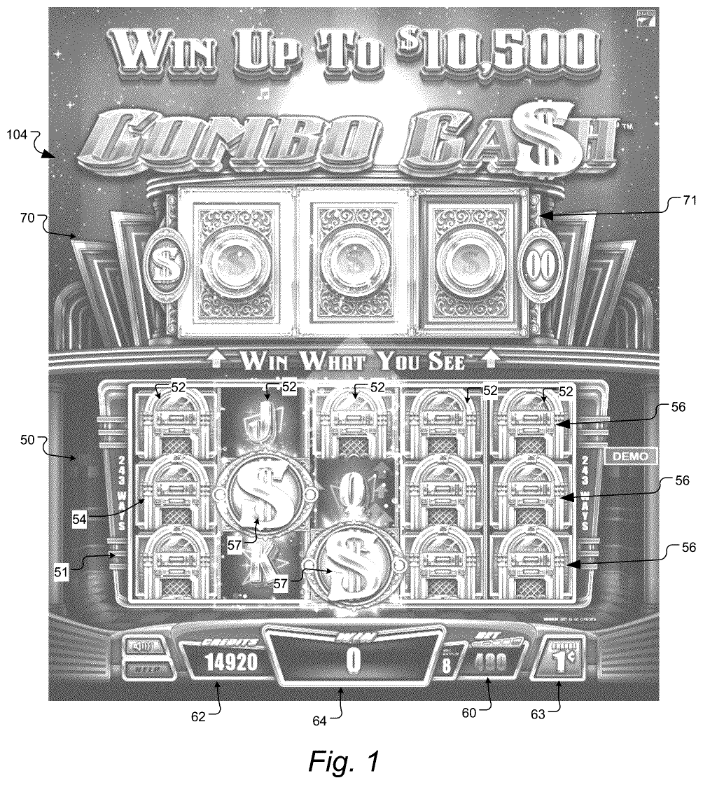

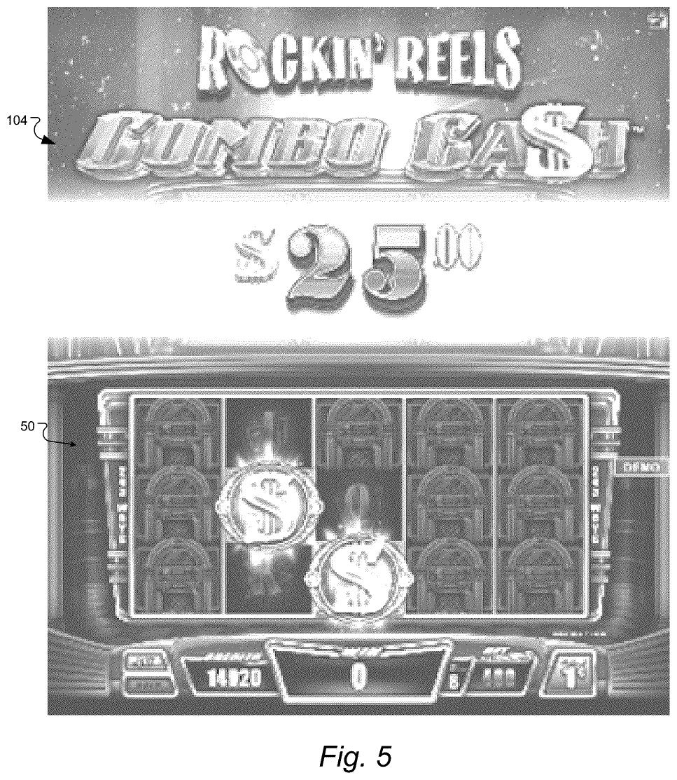

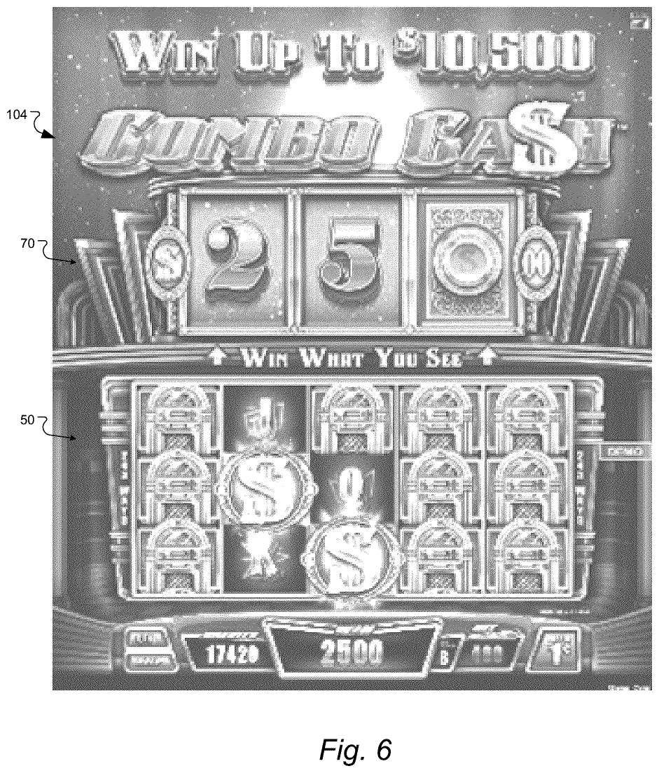

FIGS. 1-6 are a sequence of game screen diagrams illustrating an example base game scenario according to an example embodiment. The sequence starts with a base game outcome illustrated in FIG. 1, which shows a primary display 104 of a gaming machine display system on which game results are able to be presented in two gaming areas 50 and 70.

The first gaming area 50 of a reel-type primary game is a matrix 51 of symbol locations, arranged in a three rows 56 and five reels or columns 52 in this embodiment, each with three displayed symbol locations 54 which are animated to represent simulated slot machine reels presented in columns 52 that are spun to conduct a game round. Other embodiments may, of course, use other types of game displays to display randomizing of symbols according to the methods herein. In this instance there are three reels with only one symbol location 54 displayed at a time on each reel, but the techniques herein may be employed with more and less reels.

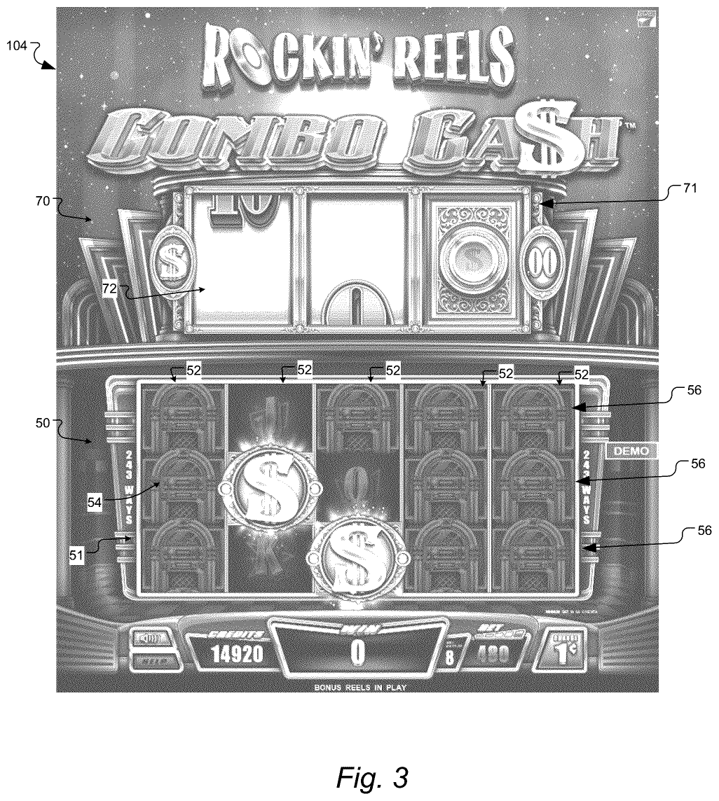

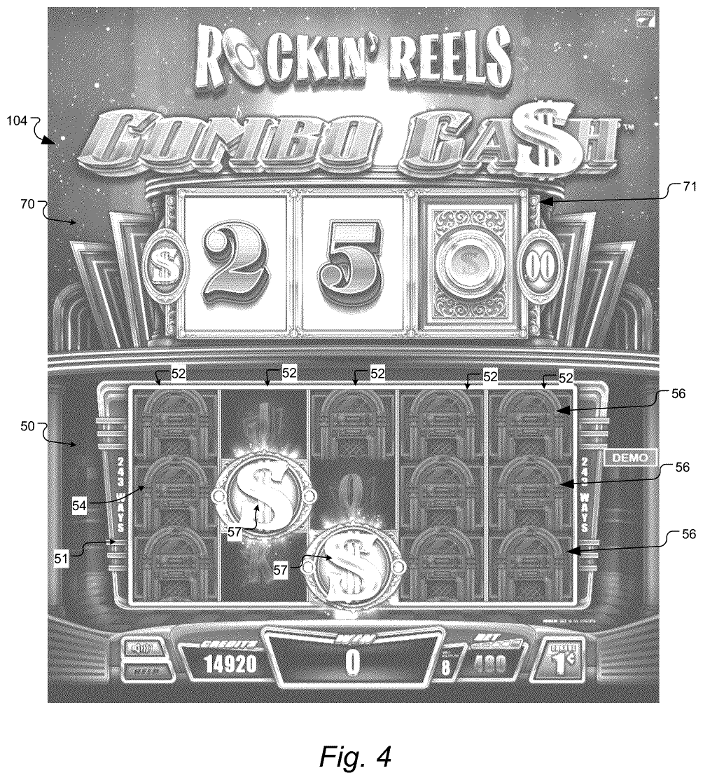

Second gaming area 70 includes a plurality of reels 71, in this embodiment displayed as separated from the first display area 50. In this embodiment, reels 71 are unisymbol reels displaying a single symbol of the reel when stopped. Each reel includes a plurality of second symbol locations 72 (FIG. 3, FIG. 4) containing a game symbol from a game symbol set which includes numerical symbols with single digit numbers including “0” and double digit numbers including “00”. Another embodiment includes a mechanical reel version with three mechanical reels. A single symbol location of each reel is visible in second gaming area 70, viewed through a window or windows present along the front of the gaming cabinet. Whether simulated reels or mechanical reels are used, each reel 71 typically has far more symbols than those displayed, and as many unique stop positions as there are symbols on the simulated reel.

Below matrix 51 is box 60, which displays the current wager amount. If an embodiment of the game uses multiple paylines, a bet per line display may be shown. Along the bottom left is box 62, which displays the current credits in the player's account. Right of this is win box 64, which displays the player's last awarded winnings. The wager credit denomination is shown in box 63.

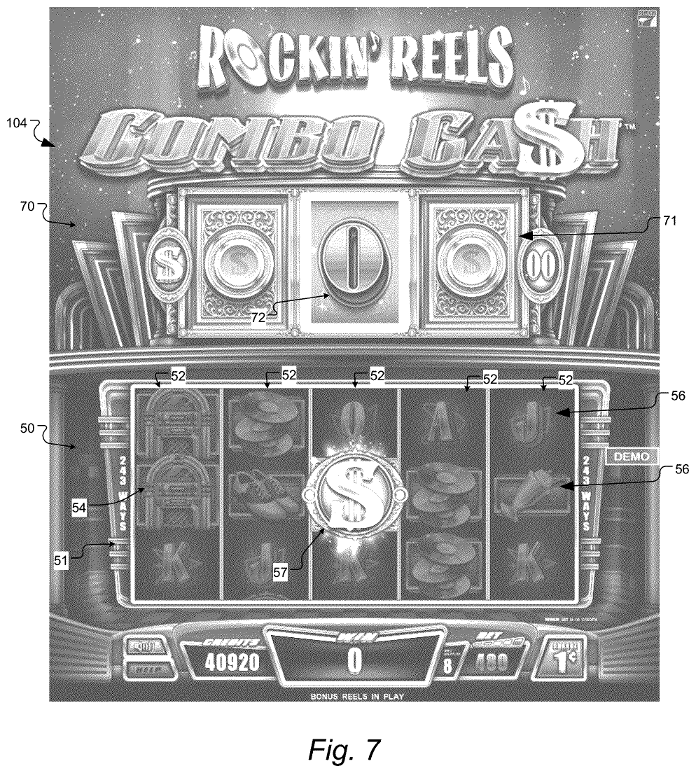

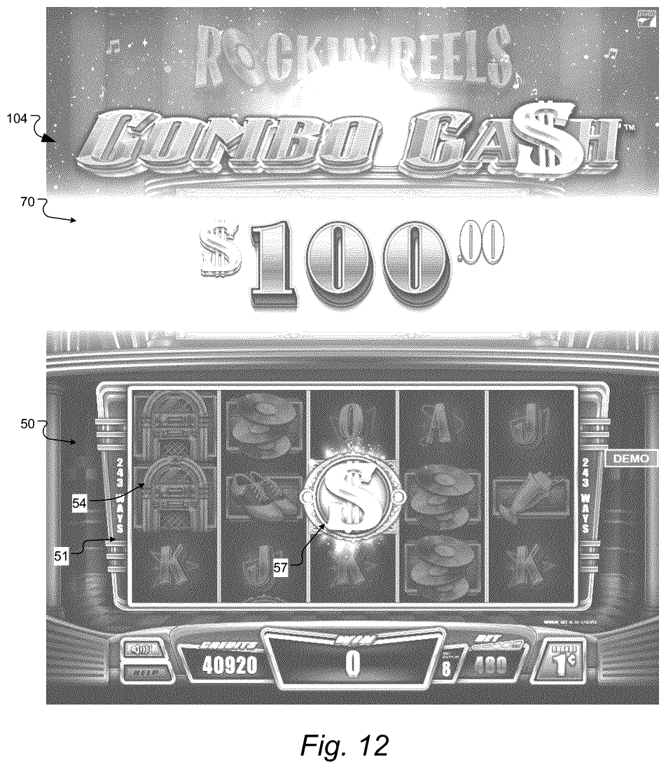

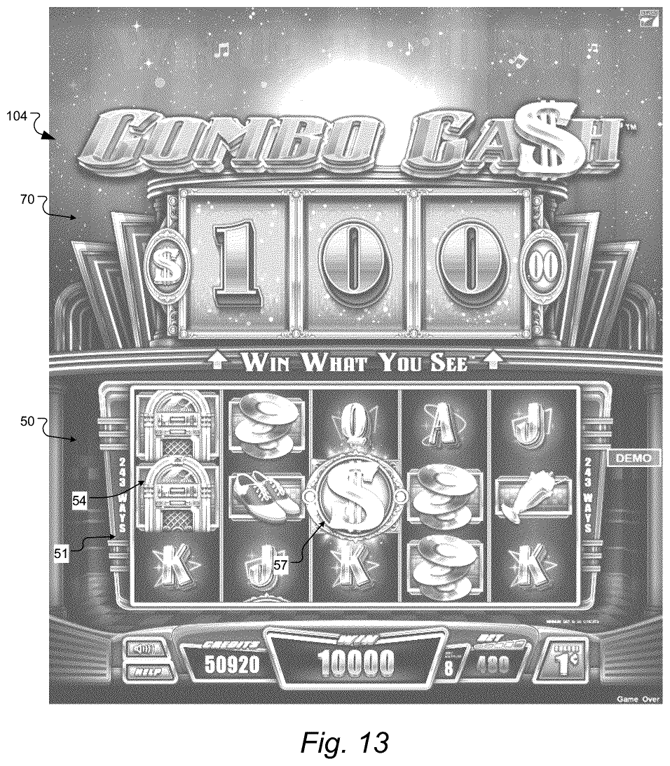

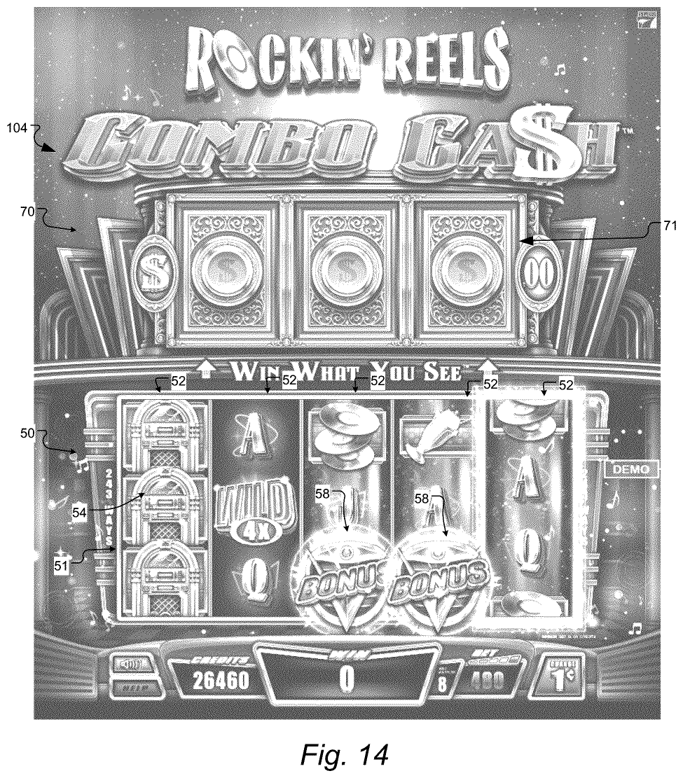

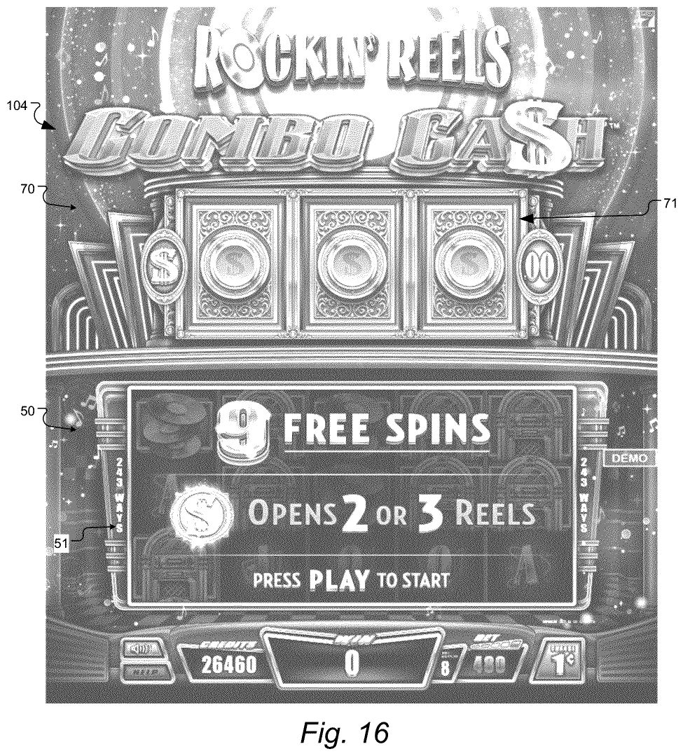

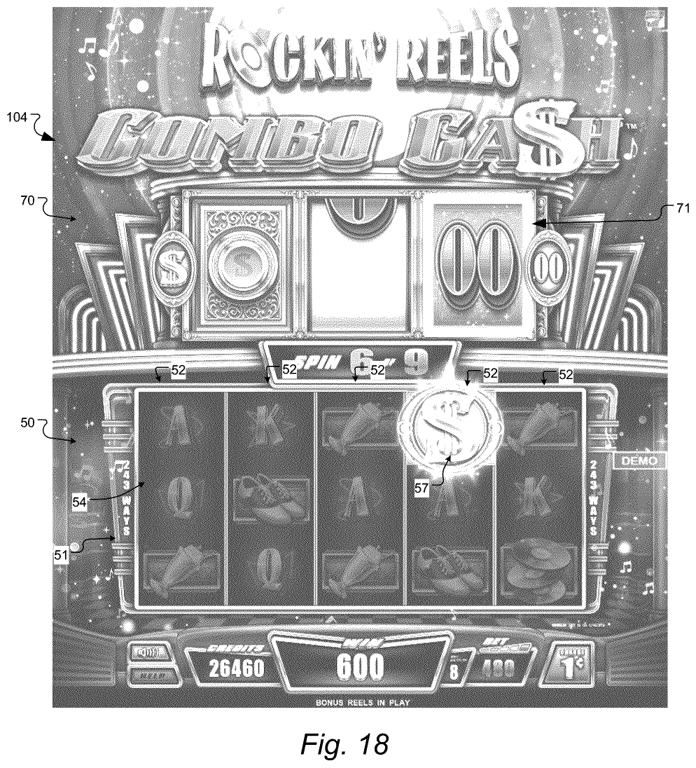

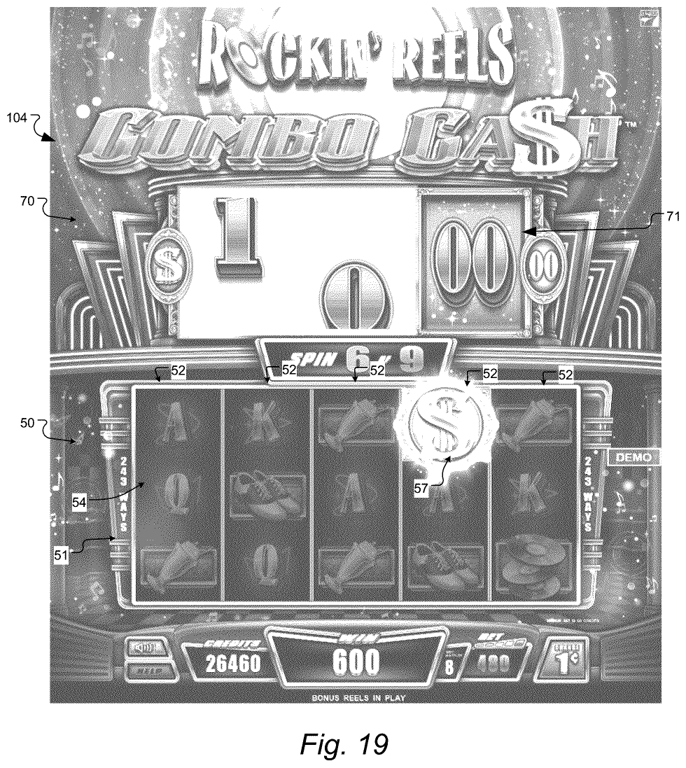

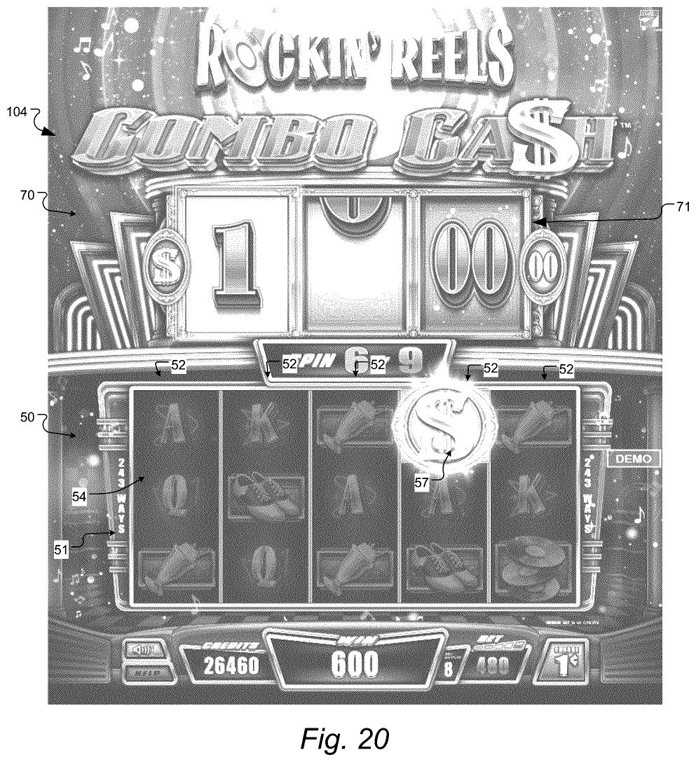

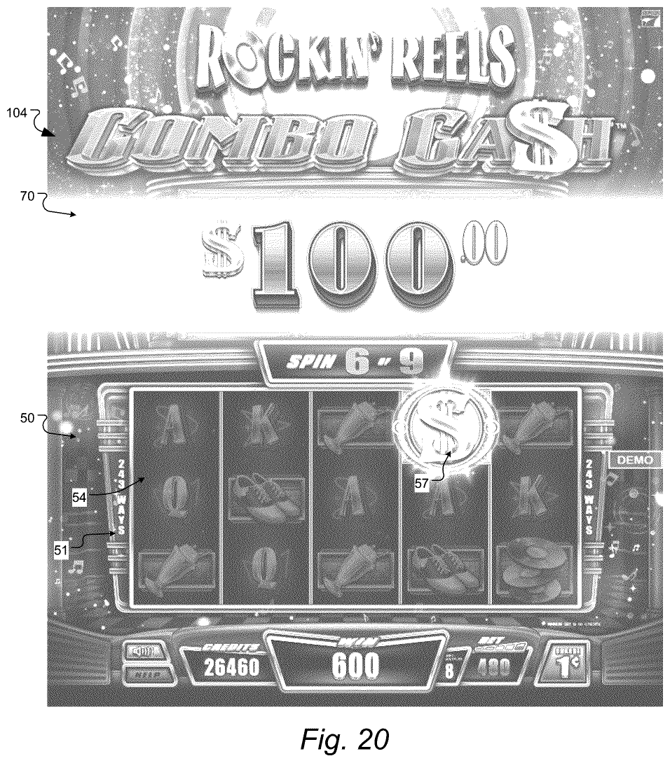

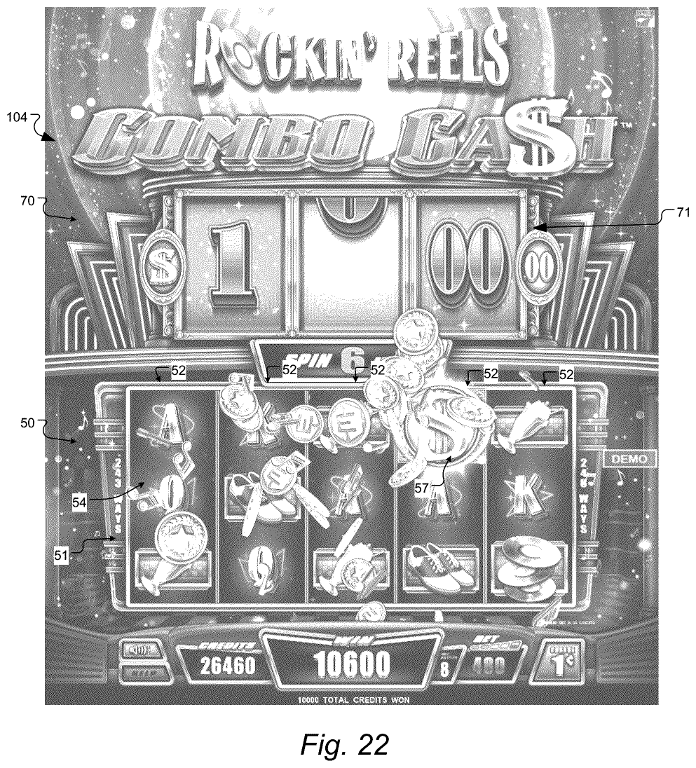

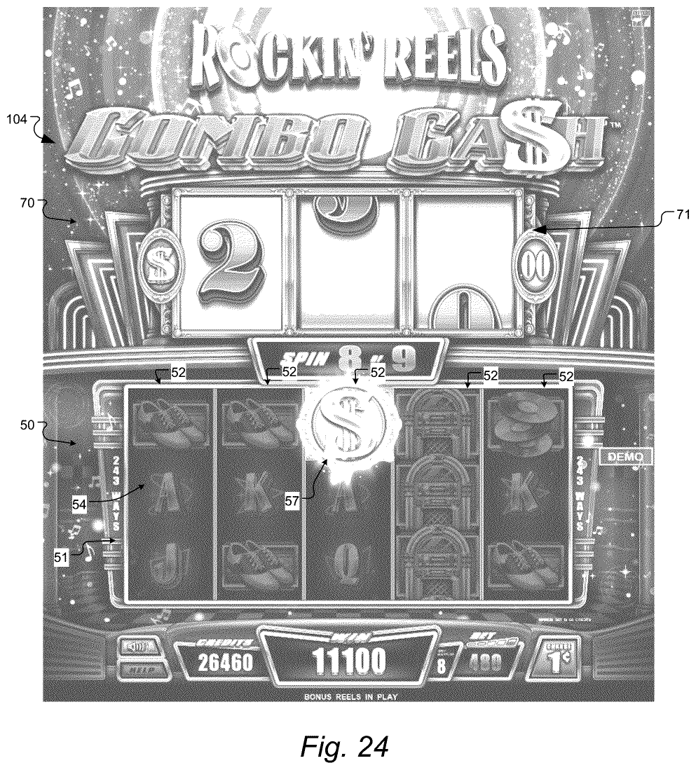

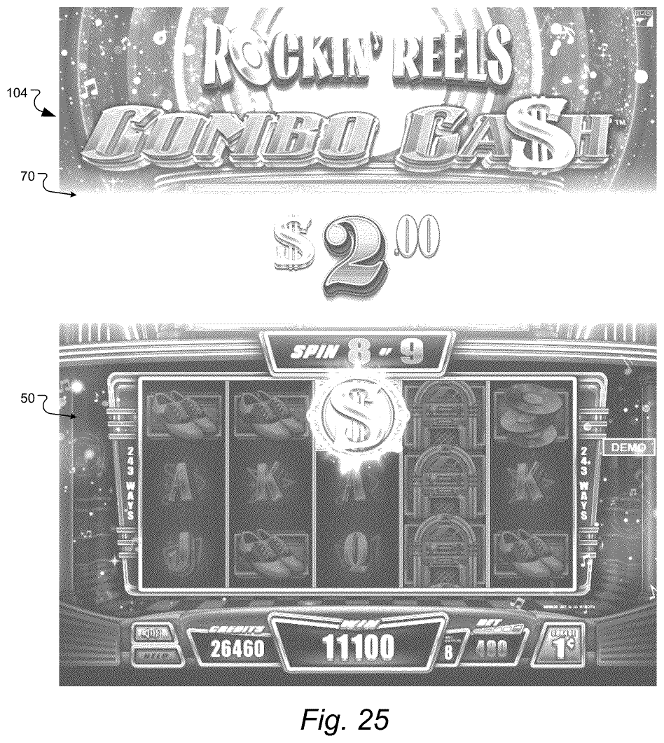

FIGS. 7-13 are a sequence of game screen diagrams illustrating another game scenario according to another example embodiment. FIGS. 14-25 are a sequence of game screen diagrams illustrating an example free spin bonus round scenario according to an example embodiment. These sequences of diagrams will be further described below.

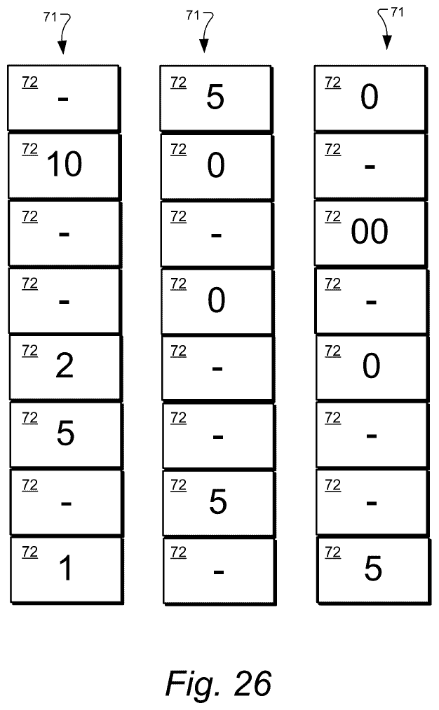

FIG. 26 is a diagram depicting the data structures for implementing the reel strips of three reels 71 used according to one preferred embodiment. The depicted reels 71 each include eight symbol locations 72, each corresponding to a stop position of the reel which shows the respective symbol along the row defined by reels 71. As shown, each reel has four blank symbols and four symbols including numbers. The blank symbols can be any graphical symbol or appearance which represents a blank according to the game evaluation set forth below. Two-digit numbers may be included, as shown by the “10” and “00” symbols.

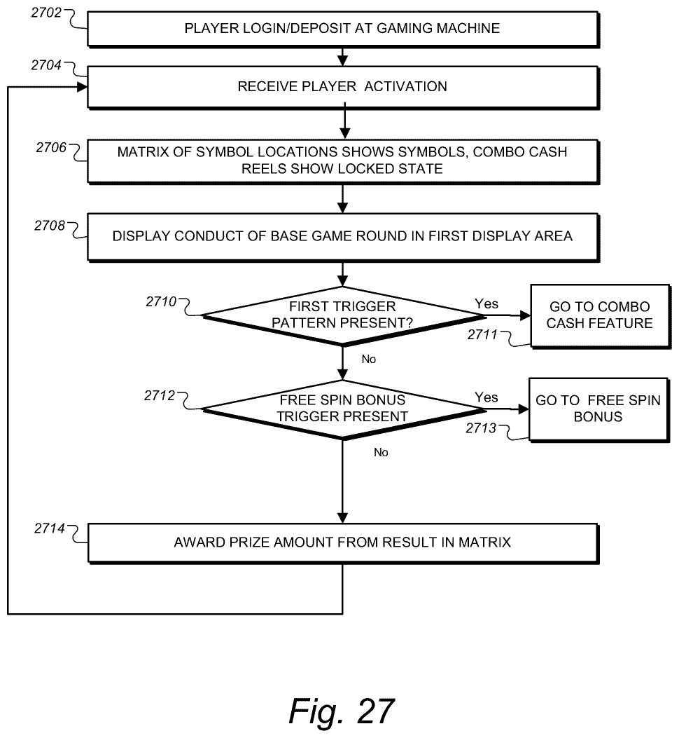

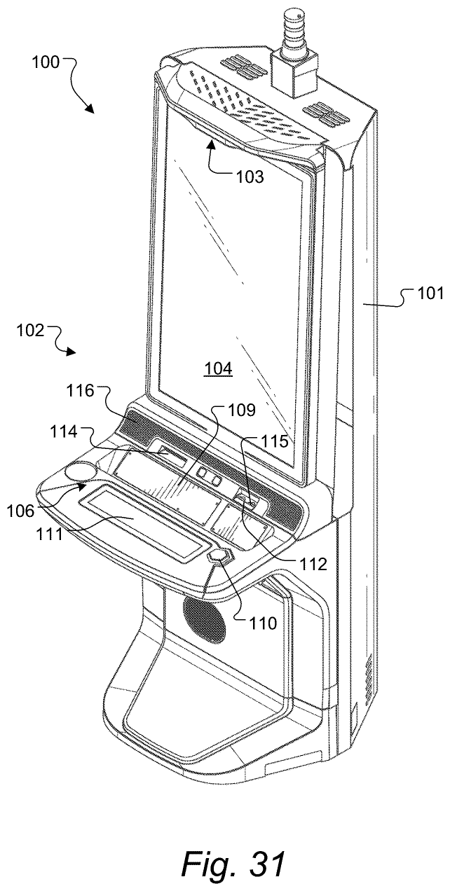

FIG. 27 is a flowchart showing a process for providing a base game according to one or more embodiments of the invention. The process is suitable for use with a suitable gaming machine, special purpose gaming machine, or thin client networked gaming system, for example those described with respect to FIGS. 31-33. Generally, the process is conducted under control of one or more electronic processors to produce and present gaming results on one or more displays on a gaming machine such as those described below. To initialize the game and make it available for playing, the process starts a game engine software package for executing the game.

For wagering game implementations, the process of providing a game for a player starts at block 2702 where a player logs in or deposits money or a credit voucher at a gaming machine. This includes receiving the player deposit through a credit input device such as the bill/voucher acceptor 112 (FIG. 31), and in response activating a credit meter value that establishes a player credit balance. For non-wagering, other forms of points or credit balances may be established.

To begin a game play, the method receives a player activation on a player input device at the gaming machine at block 2704, which typically consists of some input from the player to set the amount of points or credits to be risked or wagered from their credit amount on the machine. The amount may also be carried over from previous game rounds by simply starting the game with the previous wager amount set. This typically happens through a ‘Play’ button (110, FIG. 31) on the game cabinet or touchscreen display, and serves to place the wager and start a single round of game play in the base game. In some embodiments, the wager amount may select a number of paylines to play. In the preferred embodiment herein, the prior selected number of paylines is used to activate reels for spinning in the game unless a different selection is made.

As shown at block 2706, at this point, the matrix 51 of symbol locations shows symbol therein, while the reel symbol locations 72 are in a concealed state as shown in FIG. 1, in which they are depicted as locked or covered, and do not show symbols.

Generally, at block 2708, a base game is begun by populating the matrix 51 of symbol locations in first display area 50 with new randomly selected symbols. In embodiments in which matrix 51 uses reels, reel displays, or simulated reels, the round of play is conducted by spinning and stopping the reels to display conduct of a base game round on the reel display. Other embodiments may otherwise rearrange or randomize the symbols on the matrix in any suitable manner. For games that use other methods of scrambling the matrix besides simulated reels, the random outcome is determined at this step as appropriate for the game. A true spin of reels may be used to produce the outcome. The preferred version generates at least one random number and uses the at least one random number to determine a set of game reel stops, which is fed to a first data structure for providing the game presentation. An example game screen at this stage of the process is shown in FIG. 1. Winning patterns along paylines in matrix 51 are preferably evaluated and credited as this point.

The base game outcome includes a possibility of activating a reel-based “win what you see” feature or a free-spin bonus feature. The game outcome is evaluated for the presence of triggering patterns for such features at blocks 2710 and 2712. At block 2710, if a triggering pattern for the reel-based feature is present, the process goes to block 2711 where it conducts a reel based “win what you see” feature known as “Combo Cash” in this example embodiment. An example of such a feature is described with respect to FIG. 28 and FIGS. 1-6. In this embodiment, trigger patterns include special “dollar” symbols 57 (FIG. 1) present in the middle three columns of matrix 51. Other embodiments may use other trigger patterns.

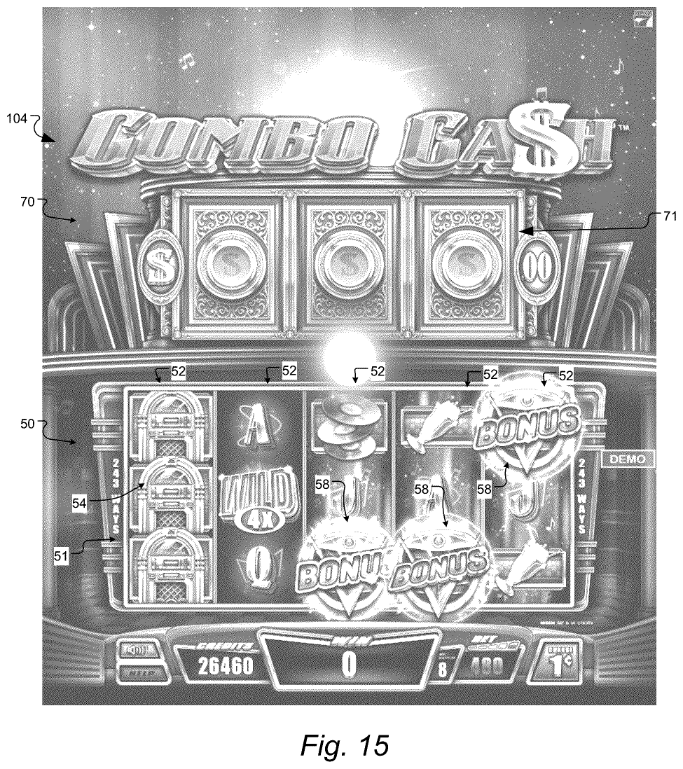

At block 2712, if a triggering pattern is found for a free-spin bonus feature, the process goes to block 2713, where it conducts a free-spin bonus game including a “win what you see” feature. An example of such a feature is described with respect to FIG. 29 and FIGS. 14-25. An example of a triggering pattern is the three “Bonus” symbols shown in FIGS. 14-15. Other embodiments may use other suitable trigger patterns.

If neither of the triggering patterns are present, the process goes to block 2714 where it ends the base game round and awards the prize amount resulting from winning patterns in the matrix 51.

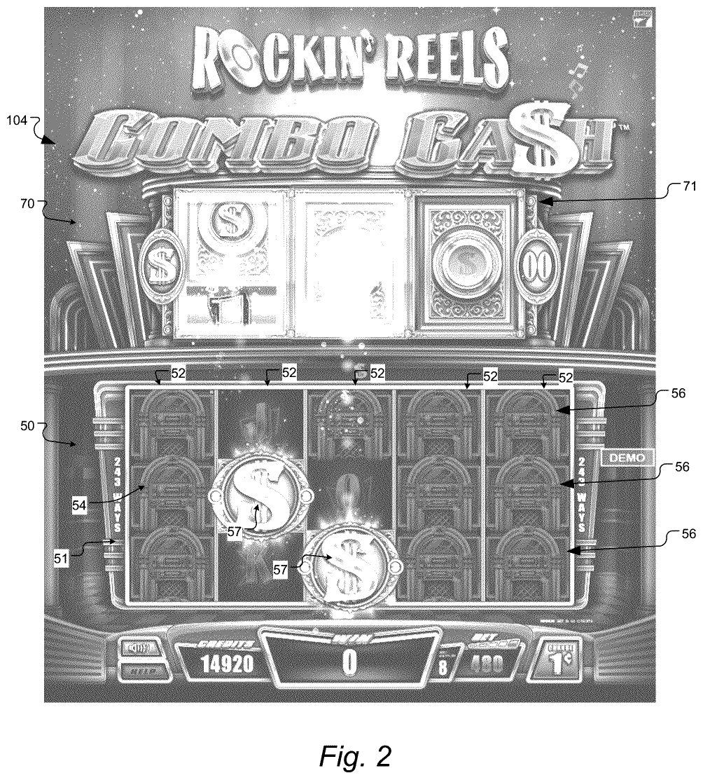

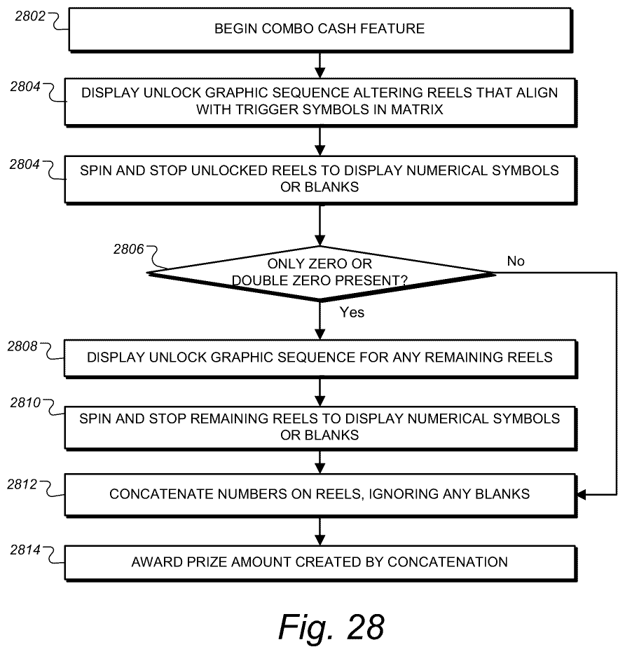

FIG. 28 is a flowchart of a process for providing a “win what you see” feature according to some embodiments. The process is suitable for use with a suitable special purpose gaming machine or a thin client networked gaming system, for example those described with respect to FIGS. 31-33. Generally, the process is conducted under control of one or more electronic processors to produce and present gaming results on one or more displays on a gaming machine such as those described below. The process is triggered, in this embodiment, by a triggering pattern such as the “Dollar” symbols 57 shown in FIG. 1, and begins at block 2802. In general, the process causes at least one of the plurality of reels to spin and stop to display a numerical value defined by concatenating the numerical symbols from the game symbol set aligned along a payline, the displayed numerical value comprising at least a portion of a randomly selected game outcome. To begin, the process at block 2804, in this embodiment, displays an unlock sequence in which the one or more of the reels 71 are displayed to be unlocked. In some embodiments, at least two of the reels are unlocked and spun at block 2804. An example of this is shown in the sequence of FIG. 1-FIG. 2 in which the left two reels 71 are unlocked and then spun. These reels are selected because they align with the columns 52 of matrix 51 in which the triggering symbols 57 appear in this example outcome.

At block 2804, the unlocked reels are spun and stopped to display numerical values or blanks. In this embodiment, each reel 71 includes a plurality of second symbol locations containing a game symbol from a game symbol set which includes numerical symbols with single digit numbers including “0” and double digit numbers including “00”, or a symbol indicating a blank. An example of the reel strips for reels 71 is shown in FIG. 26. The single and double-digit numbers are positive integers or zero/double-zero.

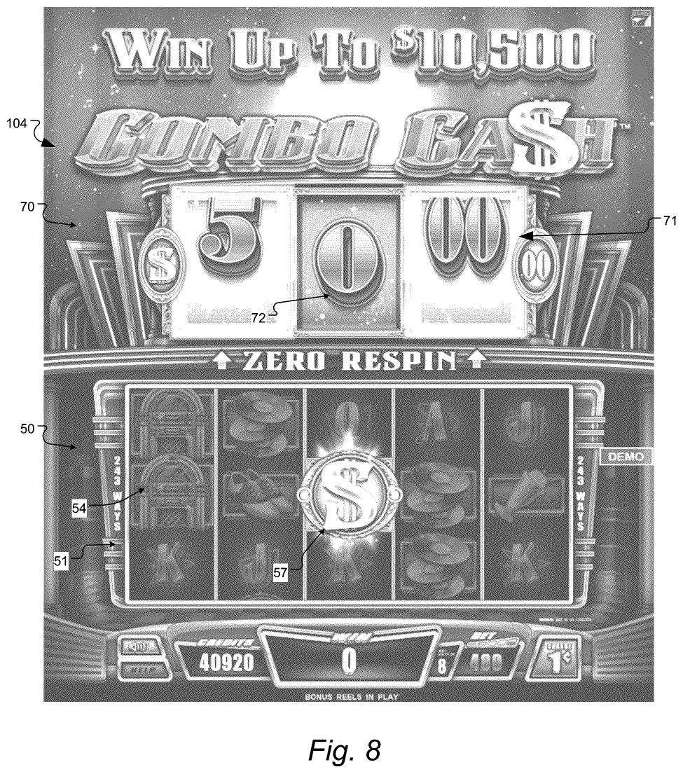

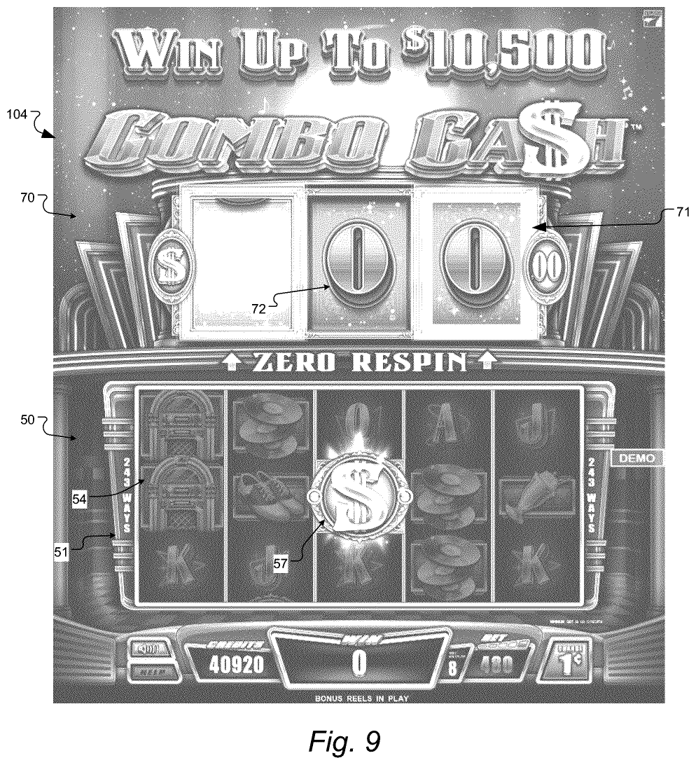

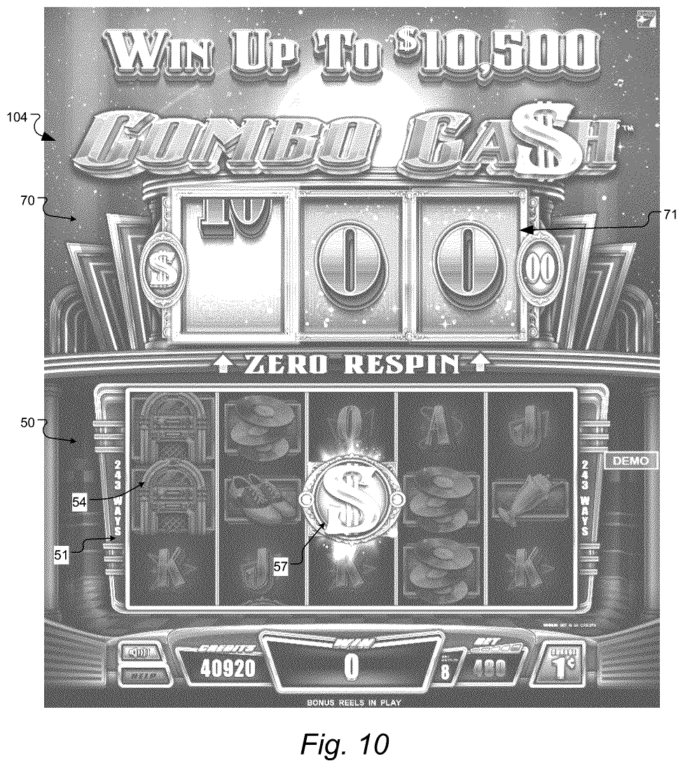

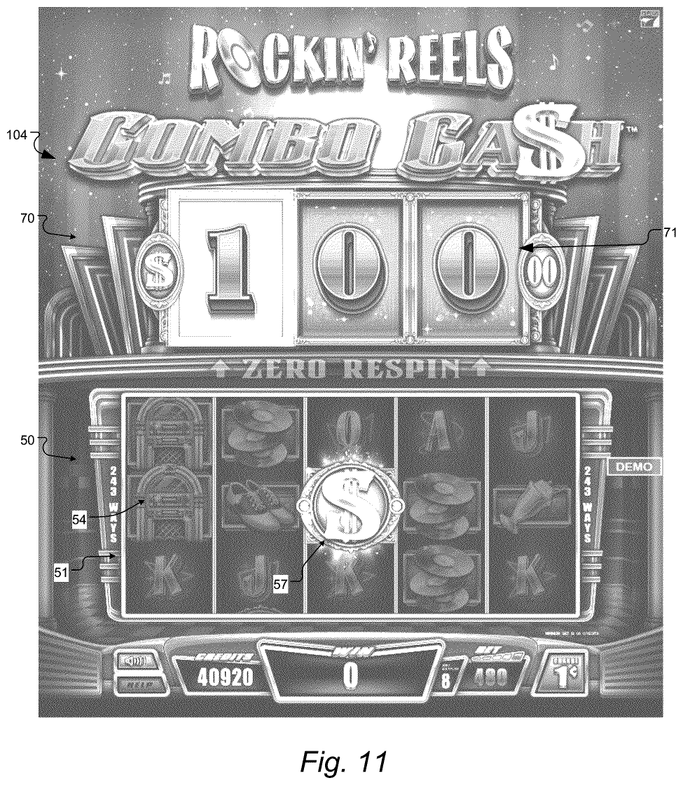

If only zero or double-zero are present in the spin result, the process at block 2806 goes to block 2808, where it displays an unlock sequence of the remaining reels. An example of such a sequence occurs from the game state depicted in FIG. 7 to the game state depicted in FIG. 8. In FIG. 7, a single Dollar symbol has triggered the unlock and spin of a single reel 71, but a zero symbol resulted from the spin. At block 2810, the remaining reels are spun and stopped to display their selected numerical symbols or blanks. An example of this is shown in FIGS. 8-11. As shown in FIG. 8, the other two reels are animated with a graphic sequence to show them being unlocked and then spun. In FIG. 9, the reel 71 on the right is stopped to build anticipation. It shows a zero symbol. In FIG. 10 the reel 71 on the left continues spinning, and stops as shown in FIG. 11 to show a “1” symbol.

At block 2812, the numbers on the reels are concatenated to provide a prize amount, ignoring any blank symbols. Then at block 2814, the process awards the prize amount created by the concatenation.

If the condition at block 2806 is not true (something besides only zero/double zero is shown), the process goes to block 2812 where it performs the concatenation (for numbers) or provides only a blank. The resulting prize is then awarded at block 2814. If only blank symbols are shown, no prize is awarded. An example of this process is shown in FIGS. 2-6, where the left two reels are unlocked and spun to provide a “2” symbol and a “5” symbol, which are concatenated at block 2812 to provide a prize of 25 credits.

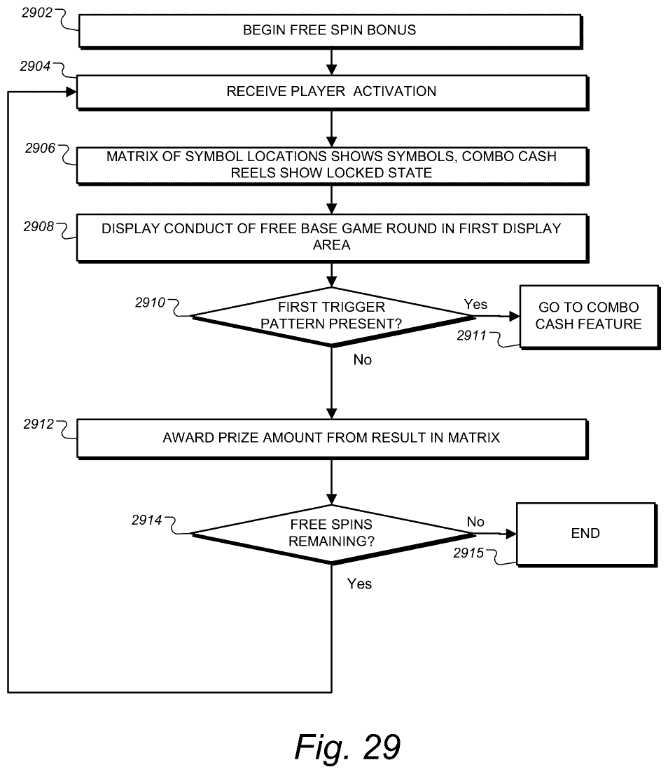

FIG. 29 is a flowchart of a process for providing a free spin bonus game according to some embodiments. The process is suitable for use with a suitable special purpose gaming machine or a thin client networked gaming system, for example those described with respect to FIGS. 31-33. Generally, the process is conducted under control of one or more electronic processors to produce and present gaming results on one or more displays on a gaming machine such as those described below.

The process begins at block 2902 with a triggering pattern for a free spin bonus occurring in a base game round, such as that described with respect to block 2712 (FIG. 27). An example of a triggering pattern and initialization of the free spin round is shown in FIGS. 14-16, with a triggering pattern in this embodiment consisting of three bonus symbols 58. Generally, the process provides a predetermined number of free spin rounds similar to the base game round of FIG. 27, but without opportunities to win a free spin round. Each free spin may include a player activation as shown at block 2904, or may proceed automatically or at timed intervals if no player activation input is received.

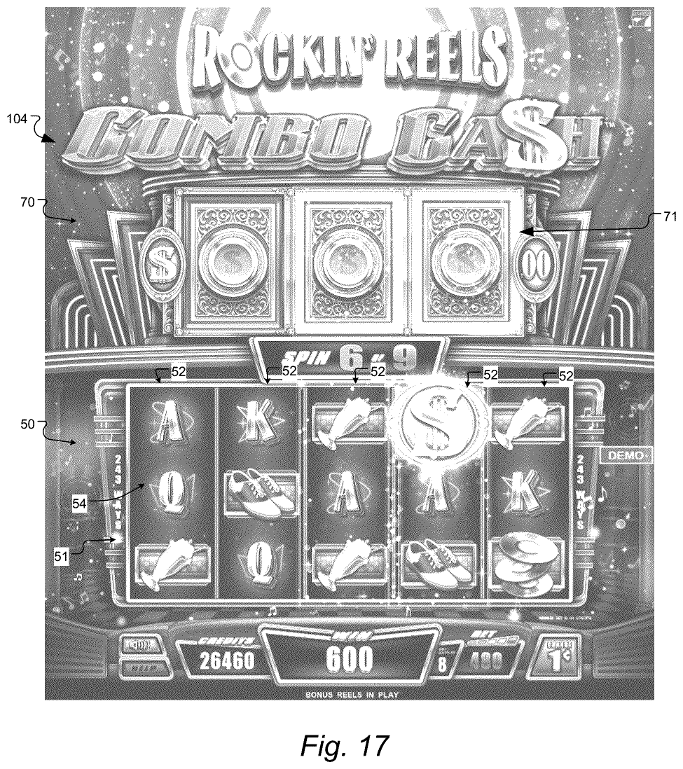

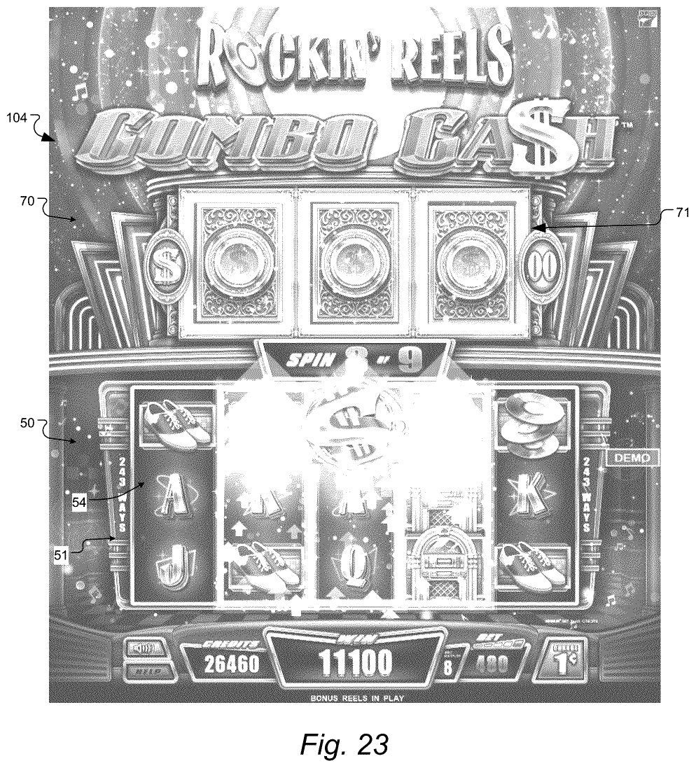

For each free spin, at block 2906 the matrix of symbol locations is populated as described at block 2706 (FIG. 27). An example of a free spin is depicted in the sequence of FIGS. 17-22. Another example free spin is depicted in the sequence of FIGS. 23-26. At block 2908, the process displays the conduct of a free base game round in the first display area. If a trigger is present in first display area result for a “win what you see” feature at block 2810, the process goes to block 2911 where it preforms the feature, in this example the “Combo Cash” feature described with respect to FIG. 28 and awards any prize from the numerical concatenation process.

If no trigger pattern is present at block 2910, at block 2912 the process awards any prize from the free spin result in the matrix. At block 2914, no free spins are remaining, the process goes to block 2915 where it ends the free spin bonus round. If free spins are remaining, the process at block 2914 returns to block 2904 to process further free spins.

While the flowcharts herein show a linear, step-by-step decision logic, this is not limiting and various implementations may use event driven or parallel logic to produce the same result.

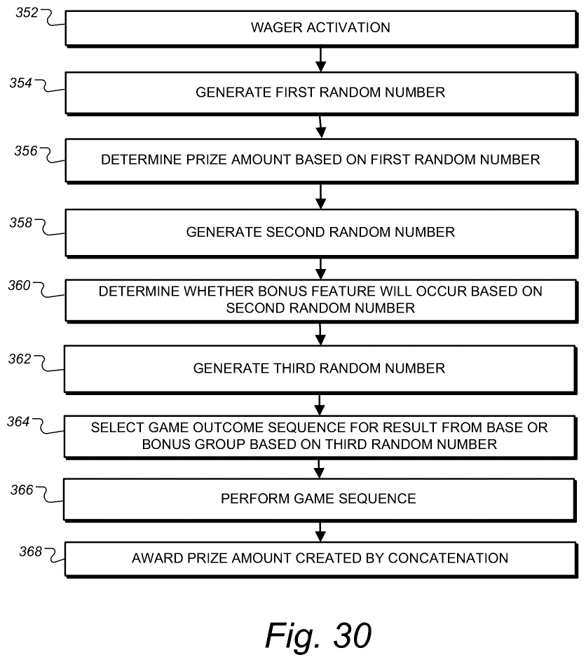

FIG. 30 is a flowchart of a process for producing game outcomes by a game engine according to an example embodiment. This is one example process by which the gaming machines gaming engine can produce gaming results.

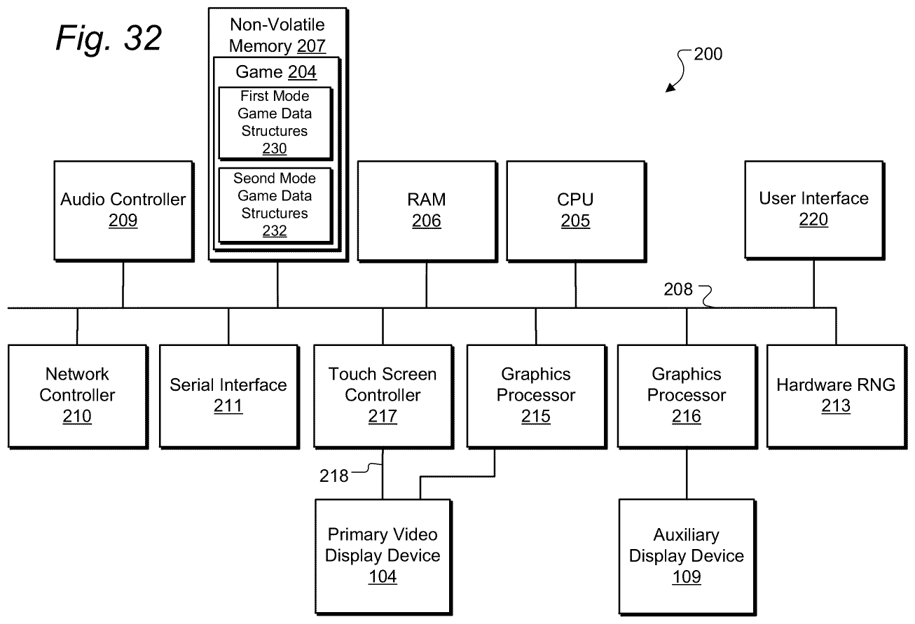

Generally, the process uses several data structures which are manipulated to conduct the game, including providing a first data structure stored in a memory of the gaming machine comprising data corresponding to reel strip data for symbol locations 72 (FIG. 26) describing symbol locations for set of reels 71 each including game symbols. The process also accesses a second data structure 230 (FIG. 32) stored in the memory including a first set of outcome sequence groups. Each of the groups corresponding to a respective prize amount, the set of outcome sequence groups including only base game outcome sequences. Base game outcome sequences include a set of reel stop positions for the reels presented in columns 52 and a prize amount, and may include further information such as a sequence identifier. A third data structure 232 is also accessed from the memory, including a second set of outcome sequence groups each corresponding to a respective prize amount, the second set of outcome sequence groups including only outcome sequences with a base game outcome and a bonus feature outcome. Bonus game outcome sequences include a set of base game reel stop positions for the reels of columns 52, a base game prize amount, and one or more sets of bonus feature reel stop positions with an associated prize amount for each. The prize amounts are defined by the reel stop positions and may not be a separate data item.

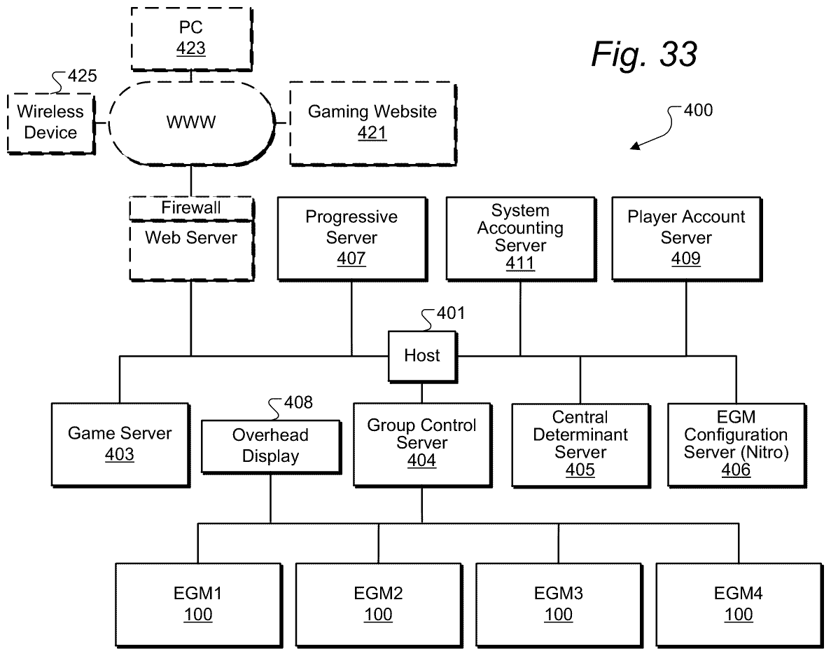

The process of FIG. 30 begins with a wager or game activation by the player at block 352. To produce a game outcome for the activation, the process at block 354 generates a first random number using a random number generator (RNG) running on the gaming machine or a suitable gaming server connected to the gaming machine over a network like that of FIG. 33. Next, at block 356, the process determines a prize amount for the game outcome based on the first random number. This step is preferably done with prize table through which designated ranges of the random number value are mapped to designated prize amounts, with the size of the ranges determining the probability of getting a particular prize amount. Prize tables are known in the art and will not be further described.

Next at block 358, the process generates a second random number, and at block 360, based on the second random number, determines whether a bonus feature will occur or the prize amount will be provided only through the base game.

To produce the base or bonus outcome, the process then at block 362 then generates a third random number. This number is used to select a game outcome sequence from the first set of outcome sequence groups (containing base game outcome sequences) or the second set of outcome sequences groups (containing bonus game outcome sequences) at block 364.

Then, at block 366, the process the process performs the game sequence, presenting the game outcome sequence using the reel display, mechanical or simulated, and if the game outcome sequence includes a bonus feature, performing the bonus feature using the reel display following the base game round. To display the gaming sequence, the process activates the first data structure to cause the game presentation to be displayed by the reel display. The resulting array of symbols is processed as described with regard to FIG. 27, and if a bonus outcome sequence was selected at block 364, the outcome sequence will also include a bonus feature process such as that of FIG. 29. The resulting award is credited at block 368.

While this example process is shown, other methods may be used to produce outcomes. For example, a true-spin or electronic true-spin may be used in which each reel is stopped at a randomized location and the outcome determined directly from the symbols produced.

Referring to FIGS. 27-30, the process functionality is controlled by the system processor by executing program code such as game program code 204 (FIG. 32), executable by a gaming machine or gaming network processor, to accomplish the functionality as described herein. It should be understood that this is only one example embodiment, and other versions may divide the processing tasks of the game method in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” In the depicted flowcharts, the method is performed by the respective computer hardware operating under control of computer program code. While central processor arrangements may vary (for example award controllers may be integrated on the same machine with a gaming server, or may be a separate server connected on a secure network), the particular central determinant architecture is not limiting and will be referred to generally in this drawing as the game server (403). To complete the base game and bonus features of FIG. 28 and FIG. 29, the thin client version of the process, performed at the game server, further includes receiving game play requests originating from electronic gaming machine 100, and sending commands to the gaming machine to show reels spinning, the graphical accumulation object, the bonus round selection process, and results being displayed. The division of game logic steps between gaming machines and servers is known in the art and may be accomplished according to suitable methods allowed for the relevant gaming jurisdictions. One or all of the gaming machines, gaming servers, or thin client devices may be special purpose devices, specialized for gaming as further described below.

FIG. 31 shows a special purpose gaming machine 100 that may be used to implement feature games according to the present invention. The block diagram of FIG. 32 shows further details of gaming machine 100. Referring to FIG. 31, gaming machine 100 includes a cabinet 101 having a front side generally shown at reference numeral 102. Gaming machine 100 includes a display system including one or more display devices such as video displays or mechanical display devices such as spinnable reels or wheels. In the depicted version, the display system includes a primary video display device 104 which is mounted in a central portion of the front side 102, with a ledge 106 positioned below the primary video display device and projecting forwardly from the plane of the primary video display device. Gaming machine 100 also includes two additional smaller auxiliary display devices, and a lower auxiliary display device 109. All of the displays may include touchscreen sensors, especially auxiliary display device 109 which may be used to present touchscreen controls for wagering. It should also be noted that each display device referenced herein may include any suitable display device including a cathode ray tube, liquid crystal display, plasma display, LED display, or any other type of display device currently known or that may be developed in the future.

By “special purpose” it is meant that gaming machine 100 is not a general-purpose computer, but instead is provided with interface devices, hardware, and software especially for providing gaming services. In some embodiments, gaming machine 100 includes a hardware-based random number may be included for generating random numbers used as described herein for providing gaming results. In some embodiments, gaming machine 100 is provided with hardware, software and/or firmware approved by an appropriate gaming regulatory authority for the jurisdiction in which it is used. For example, the hardware, software and firmware may be regulated and approved (and subject to digital verification) by one or more of the National Indian Gaming Commission (NIGC), the Arizona Department of Gaming, the California Gambling Control Commission, the California Bureau of Gambling Control, the Colorado Division of Gaming, the Connecticut Division of Special Revenue, the Delaware Lottery, the Delaware Division of Gaming Enforcement, the Illinois Gaming Board, the Indiana Gaming Commission, the Iowa Racing and Gaming Commission, the Kansas Racing and Gaming Commission, the Louisiana Gaming Control Board, the Maine Gambling Control Board, the Maryland Lottery, the Massachusetts Gaming Commission, the Michigan Gaming Control Board, the Mississippi Gaming Commission, the Missouri Gaming Commission, the Nevada Gaming Commission, the Nevada Gaming Control Board, the New Jersey Casino Control Commission, the New Jersey Division of Gaming Enforcement, the New Mexico Gaming Control Board, the New York State Gaming Commission, the Ohio Casino Control Commission, the Pennsylvania Gaming Control Board, the South Dakota Commission on Gaming, the Washington State Gambling Commission, and West Virginia Lottery Commission. In some embodiments, similar gaming regulatory authorities in non-U.S. countries may approve the hardware, software, and/or firmware. The particular regulations applied may be current regulations or future regulations promulgated after the time of filing this disclosure. Special purpose gaming machines and servers may also include a security processor for checking the digital signatures of regulated software and firmware modules to ensure they match those approved by the relevant gaming regulators.

In preferred versions, the gaming machine 100 illustrated in FIG. 31 also includes a number of mechanical control buttons 110 mounted on ledge 106. These control buttons 110 may allow a player to select a bet level, select paylines, select a type of game or game feature, and activate a play in the primary game. Further, primary video display device 104 in gaming machine 100 provides a convenient display device for implementing touchscreen controls.

Gaming machine 100 may also include a number of other player interface devices in addition to devices that are considered player controls for use in playing a particular game. Ledge 106 may also include a hardware special object including a button, touch sensor, or switches, joysticks, or other mechanical input devices, and/or virtual buttons and other controls implemented on a suitable touchscreen video display. Gaming machine 100 also includes a currency/voucher acceptor 112 having an input ramp, a player card reader having a player card input 114, and a voucher/receipt printer having a voucher/receipt output 115. One or more of these devices provides a credit input device in communication with the controller and adapted for accepting a physical item associated with a monetary value that establishes a player credit balance. Audio speakers 116 generate an audio output to enhance the user's playing experience. Numerous other types of devices may be included in gaming machines that may be used according to the present invention.

FIG. 32 shows a hardware and logical block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on system bus 208 and is connected to drive primary video display device 104 (mounted in cabinet 101 as shown in FIG. 31). A second graphics processor 216 is also connected on system bus 208 in this example to drive the auxiliary display device 109 also shown in FIG. 31. Gaming machine 100 also includes a touch screen controller 217 connected to system bus 208. Touch screen controller 217 is also connected via signal path 218 to receive signals from a touchscreen element associated with primary video display device 104. It will be appreciated that the touchscreen element itself typically comprises a thin film that is secured over the display surface of primary video display device 104. The touchscreen element itself is not illustrated or referenced separately in the figures.

Those familiar with data processing devices and systems will appreciate that other common electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 32 are known elements used in the gaming machine industry. These elements are preferably mounted in a computer chassis which is housed in cabinet 101 shown in FIG. 31. Alternatively, the various electronic components may be mounted on one or more circuit boards or modules housed within cabinet 101 without a separate enclosure. Those familiar with data processing systems and the various data processing elements shown in FIG. 32 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 32 as being connected directly on system bus 208 may in fact communicate with the other system components through a suitable expansion bus. Audio controller 209, for example, may be connected to the system via a PCI bus. System bus 208 is shown in FIG. 32 merely to indicate that the various components are connected in some fashion for communication with game processor/CPU 205 and is not intended to limit the invention to any particular bus architecture. Numerous other variations in the gaming machine internal structure and system may be used without departing from the principles of the present invention.

Although separate graphics processor 215 is shown for controlling primary video display device 104, and graphics processor 216 is shown for controlling both auxiliary display device 109, it will be appreciated that game processor/CPU 205 may control all of the display devices directly without any intermediate graphics processor. The invention is not limited to any particular arrangement of processing devices for controlling the video display device included with gaming machine 100. Also, a gaming machine implementing the present invention is not limited to any particular number of video display devices or other types of display devices.

In the illustrated gaming machine 100, game processor/CPU 205 executes software which ultimately controls the entire gaming machine including the receipt of player inputs and the presentation of the graphic symbols displayed according to the invention through the display devices 104 and 109 associated with the gaming machine. As will be discussed further below, game processor/CPU 205 either alone or in combination with graphics processor 215 may implement a presentation controller for performing functions associated with a primary game that may be available through the gaming machine, and may also implement a game client for directing one or more display devices at the gaming machine to display the feature game mode according to the present invention. Game processor/CPU 205 also executes software related to communications handled through network controller 210, and software related to various peripheral devices such as those connected to the system through audio controller 209, serial interface 211, and touch screen controller 217. Game processor/CPU 205 may also execute software to perform accounting functions associated with game play. Random access memory 206 provides memory for use by game processor/CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included.

It should be noted that the invention is not limited to gaming machines employing the arrangement of processing devices and interfaces shown in example gaming machine 100. Other gaming machines through which the features herein are implemented may include one or more special purpose processing devices to perform the various processing steps for implementing the present invention, such as generating random numbers or checking the security status of software packages or gaming credit vouchers. Unlike processing devices such as game processor/CPU 205, these special purpose processing devices may not employ operational program code to direct the various processing steps.

Still referring to the hardware and logical block diagram 200 showing an example design for a gaming machine 100, the depicted machine in operation is controlled generally by game processor/CPU 205 which stores operating programs and data in non-volatile memory or storage device 207 with game module 204, and software or drivers for user interface 220, network controller 210, audio/visual controllers, and a hardware random number generator (RNG) 213, which is employed if software RNG procedures are not allowed in a particular gaming jurisdiction. Either hardware RNG 213 or a suitable software RNG are employed for making the random selections of game outcomes, reel stop positions, etc. when operating the game as described herein. The game module 204, once installed, also is held in non-volatile memory of the EGM, preferably a separate flash drive or hard drive from the memory holding the EGM operating system. CPU or game processor/CPU 205 may comprise a conventional microprocessor, such as an Intel microprocessor, mounted on a printed circuit board with supporting ports, drivers, memory, software, and firmware to communicate with and control gaming machine operations, such as through the execution of coding stored in non-volatile memory or storage device 207 including one or primary game modules 202, including executable code and data structures such as data structures 230 for performing the primary game in the mode, and data structures 232 for performing the second gaming mode including one or more of the reels in the secondary display area activated. Game processor/CPU 205 connects to user interface 220 such that a player may enter input information, and game processor/CPU 205 may respond according to its programming, such as to apply a wager and initiate execution of a game.

Game processor/CPU 205 also may connect through network controller 210 to a gaming network, such as example casino server network 400 shown in FIG. 15.

Referring now to FIG. 33, the casino server network 400 may be implemented over one or more site locations and include host server 401, and an EGM configuration server 406 for managing the configuration of multiple EGMs 100 on the network. A group display device 408 is coupled to casino server network 400 may include its own controller and graphics processor for driving the group display in response to commands received over a network connection. The network may also include remote game play server 403 (which may be configured to provide game processor functionality including determining game outcomes and providing audio/visual instructions to a remote gaming device), a group control server 404 (which controls the gaming mode of the group of gaming machines including determining when to change the gaming mode and controlling the meters in the second gaming mode), central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards. While some of the servers have been shown separately, they may be combined or split into additional servers having additional capabilities.

As shown, networked electronic gaming machines 100 (EGM1-EGM4) and one or more overhead group displays 413 may be network connected and enable the content of one or more displays of gaming machines 100 to be mirrored or replayed on an overhead display. EGMs 100 may also feed celebration graphics directly to the overhead displays 413 in the course of providing games, for example to show a celebration for a large bonus win or group gaming mode win on a particular EGM 100. Typically the overhead display function and group celebration scenarios are managed by a floor messaging server such as Nitro floor messaging server 404, which receives messages from EGM's 100 to communicate group gaming mode wins, bonus game wins, or awards of other large prizes such as progressive prizes. The primary display content may also be stored by the display controller or game processor/CPU 205 and transmitted through network controller 210 to the overhead display controller either substantially simultaneously or at a subsequent time according to either periodic programming executed by game processor/CPU 205 or a triggering event, such as a jackpot or large win, at a respective gaming machine 100. In the event that gaming machines 100 have cameras installed, the respective player's video images may be displayed on overhead display 413 along with the content of the player's gaming machine 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor/CPU 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Apple iPhone, Android phone, tablet, phablet, virtual reality device, iPad, etc.). To enter the website, a player may log in with a username (that may be associated with the player's account information stored on player account server 409 or be accessible by a casino operator to obtain player data and provide promotional offers), play various games on the website, make various personalizing selections and save the information, so that during a next gaming session at a casino establishment, the player's playing data and personalized information may be associated with the player's account and accessible at the player's selected gaming machine 100.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A special purpose gaming machine comprising:
(a) a display system displaying a matrix of first symbol locations in a first display area and a plurality of reels in a second display area separate from the first display area and each of the plurality of reels including a plurality of second symbol locations containing a game symbol from a game symbol set which includes numerical symbols with single digit numbers including “0” and double digit numbers including “00”;
(b) a player input device; and
(c) at least one electronic processor operatively coupled to the display system and the player input device, the at least one electronic processor being operable to, in response to an input from the player input device, cause the display system to populate the matrix of first symbol locations and, responsive to a designated triggering pattern appearing therein, cause at least two of the plurality of reels to spin and stop to display a numerical value defined by concatenating the numerical symbols from the game symbol set aligned along a payline, the displayed numerical value comprising at least a portion of a randomly selected game outcome.

2. The special purpose gaming machine of claim 1 wherein each second symbol locations of each reel contains a positive single digit number, a positive double digit number, “0,” “00,” or a non-numerical symbol comprising a blank symbol.

3. The special purpose gaming machine of claim 1 wherein the at least one electronic processor is operable to, responsive to the designated triggering pattern, cause the at least two reels to change from a first state in which they are shown to be concealed, and a second state in which they are shown to be active and displaying symbols.

4. The special purpose gaming machine of claim 1 wherein the at least one electronic processor is further operable to, responsive to the designated triggering pattern, select the at least two of the plurality of reels that spin and stop to be reels that are aligned with two or more symbols containing the triggering pattern.

5. The special purpose gaming machine of claim 1 wherein the at least one electronic processor is further operable to, in response to a spin result of the reels containing only ‘0’ or ‘00’ values, causing the remaining reels to spin and stop to display a numerical value defined by concatenating the numerical symbols from the game symbol set aligned along the payline, the displayed numerical value comprising at least a portion of a randomly selected game outcome.

6. The special purpose gaming machine of claim 1 wherein the at least one electronic processor is further operable to:
(a) perform a prize amount random selection to identify an outcome prize amount; and
(b) perform an outcome sequence random selection to identify an outcome sequence from a group of outcome sequences each providing the identified outcome prize amount.

7. The special purpose gaming machine of claim 6 wherein:
(a) the at least one electronic processor is further operable to perform an outcome group random selection to select between a first group of outcome sequences and a second group of outcome sequences to identify a selected group of outcome sequences where the first group of outcome sequences includes only base game outcome sequences and the second group of outcome sequences includes only outcome sequences having a base game outcome and a bonus game outcome; and
(b) the group of outcome sequences from which the outcome sequence identified in accordance with the outcome display random selection is the group of outcome sequences selected from the outcome group random selection.

8. A method for controlling operation of a gaming machine, the method including:
(a) under control of a processing system of the gaming machine, storing a first data structure in a memory of the gaming machine, the first data structure for forming a matrix of symbol locations on a display system of the gaming machine, and storing a second data structure for forming set of reel strips for a plurality of reels each including a plurality of second symbol locations containing a game symbol from a game symbol set which includes numerical symbols with single digit numbers including “0” and double digit numbers including “00”; and
(b) in response to an input entered through a player input device of the gaming machine and under control of the processing system, causing the display to populate the matrix of first symbol locations in a first area of the display system and, responsive to a designated triggering pattern appearing therein, cause at least two of the plurality of reels to spin and stop in a second area of the display system to display a numerical value defined by concatenating the numerical symbols from the game symbol set aligned along a payline, the displayed numerical value comprising at least a portion of a randomly selected game outcome.

9. The method of claim 8 wherein all of the game symbols in the game symbol set comprise positive single digit numbers, positive double digit numbers, “0,” “00,” and blank symbols.

10. The method of claim 8 further comprising, responsive to a designated triggering pattern, causing the at least two reels to change from a first state in which they are shown to be concealed, and a second state in which they are shown to be active and displaying symbols.

11. The method of claim 8 further comprising, responsive to the triggering pattern, selecting the at least two of the plurality of reels that spin and stop to be reels that are aligned with two or more symbols containing the triggering pattern.

12. The method of claim 8 further comprising, responsive to a spin result of the reels containing only ‘0’ or ‘00’ values, causing the remaining reels to spin and stop to display a numerical value defined by concatenating the numerical symbols from the game symbol set aligned along the payline, the displayed numerical value comprising at least a portion of a randomly selected game outcome.

13. The method of claim 8 wherein the randomly selected game outcome is selected by:
(a) performing a prize amount random selection to identify an outcome prize amount; and
(b) performing an outcome sequence random selection to identify an outcome sequence from a group of outcome sequences each providing the identified outcome prize amount.

14. The method of claim 8 further comprising:
(a) storing a second data structure in the memory, the second data structure comprising a first group of outcome sequences each corresponding to a respective prize amount and each including only base game outcome sequences;
(b) storing a third data structure in the memory, the third data structure comprising a second group of outcome sequences each corresponding to a respective prize amount and each including only outcome sequences with a base game outcome and a bonus game outcome; and
(c) in response to the input and after identifying an outcome prize amount, randomly selecting an outcome sequence from one of the first group of outcome sequences or the second group of outcome sequences.

15. The method of claim 8 further comprising:
(a) under control of the processing system, causing the display system to show each of the plurality of reels spin and then come to a stop to display a first group of symbols from the game symbol set aligned along the payline, the first group of symbols including “0”; and
(b) under control of the processing system, causing a reel that does not display “0” in the first group of symbols from the game symbol set to respin and then come to a stop to display the numerical value defined by concatenating the numerical symbols from the game symbol set aligned along the payline.

16. One or more tangible non-transitory computer readable media holding a program product for controlling operation of a reel-type gaming machine, the program product comprising machine readable instructions executable by a processing system for:
(a) under control of a processing system of the gaming machine, storing a first data structure in a memory of the gaming machine, the first data structure comprising data corresponding to a set of reel strips for a plurality of reels each having a plurality of symbol locations, each symbol location containing a game symbol selected from a game symbol set including a non-numerical symbol and numerical symbols including single digit numbers including “0” and double digit numbers including “00”; and
(b) in response to an input entered through a player input device of the gaming machine and under control of the processing system, causing a display system of the gaming machine to show each of the plurality of reels spin and then come to a stop at least once to display a numerical value defined by concatenating the numerical symbols from the game symbol set aligned along a payline, the displayed numerical value comprising at least a portion of a randomly selected game outcome.

17. The media of claim 16 wherein all of the game symbols in the game symbol set comprise positive single digit numbers, positive double digit numbers, “0,” “00,” and blank symbols.

18. The media of claim 16 wherein the instructions are further executable for, responsive to a designated triggering pattern, cause the at least two reels to change from a first state in which they are shown to be concealed, and a second state in which they are shown to be active and displaying symbols.

19. The media of claim 16 wherein the instructions are further executable for, responsive to the triggering pattern, selecting the at least two of the plurality of reels that spin and stop to be reels that are aligned with two or more symbols containing the triggering pattern.

20. The media of claim 16 wherein the instructions are further executable for:
(a) performing a prize amount random selection to identify an outcome prize amount; and
(b) performing an outcome sequence random selection to identify an outcome sequence from a group of outcome sequences each providing the identified outcome prize amount.
